(19) United States
(12) Patent Application Publication
(10) Pub. No.: US 2008/0075315 A1
(43) Pub. Date: Mar. 27, 2008

(54) Bluetooth earphone

(76) Inventor: Cheng-Yuan Yu, Taiwan City (TW)

Correspondence Address: Thomas E. Sisson;Jackson Walker, LLP, Suite 2100, 112 E. Pecan, San Antonio, TX, 78205, US

(21) Appl. No.: 11/519,654

(22) Filed: Sep. 12, 2006

(51) Int. Cl. H04R 25/00

(52) U.S. Cl. 381/374; 381/380

(57) ABSTRACT

A bluetooth earphone has an earphone jacket, an earphone module, a bluetooth module, a receiver, a speaker and a rolling assembly. The earphone jacket has multiple receiving holes, a through hole and an opening defined in a sidewall. The earphone module provided in the earphone jacket and respectively connects to the bluetooth module, the receiver and the speaker. The speaker connects to the earphone module via a wire and the wire extends out of the opening. The rolling assembly is provided in the earphone jacket and corresponds to the through hole and the opening whereby the wire can be rolled around the rolling assembly to avoid tangling.

### BACKGROUND OF THE INVENTION

1. Field of the Invention

The present invention relates to an earphone, and more particularly to a bluetooth earphone that can be conveniently used for a cell phone.

2. Description of the Related Art

Bluetooth is a wireless transferring technology with low efficiency and short distance. The main feature is that it can transfer information, image and sound, etc. Compared with infrared, the bluetooth has no direction limit.

However, when the bluetooth is applied for a cell phone, there is still a wire between a receiver of the earphone and a speaker of the earphone with inconveniency.

Therefore, the invention provides a bluetooth earphone to mitigate or obviate the aforementioned problems.

### SUMMARY OF THE INVENTION

The main objective of the present invention is to provide a bluetooth earphone that can be conveniently received in a cell phone.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bluetooth earphone in accordance with the present invention;

FIG. 2 is a partially exploded perspective view of the bluetooth earphone in FIG. 1;

FIG. 3 is a side view in partial section of the bluetooth earphone in FIG. 1;

FIG. 4 is a side view in partial section of the bluetooth earphone in FIG. 1; and

FIG. 5 is block diagram of the bluetooth earphone in FIG. 1.

### DETAILED DESCRIPTION OF THE PREFERRED EMBODIMENT

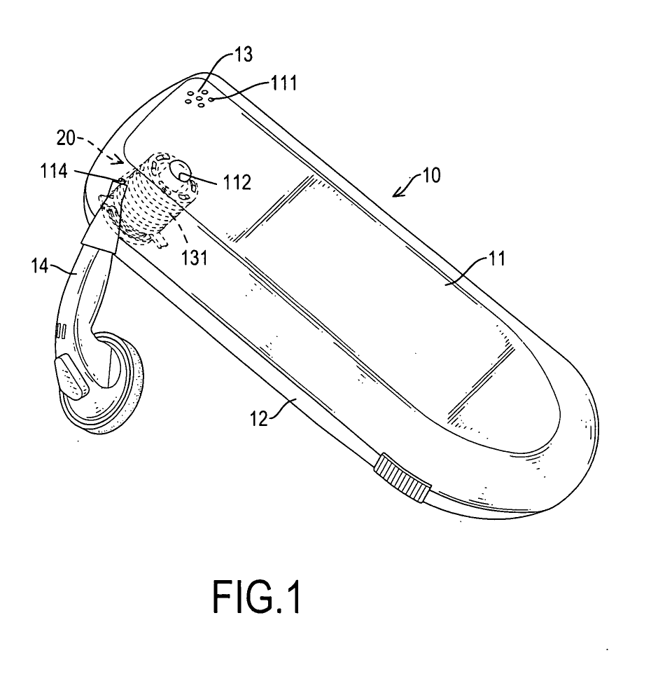

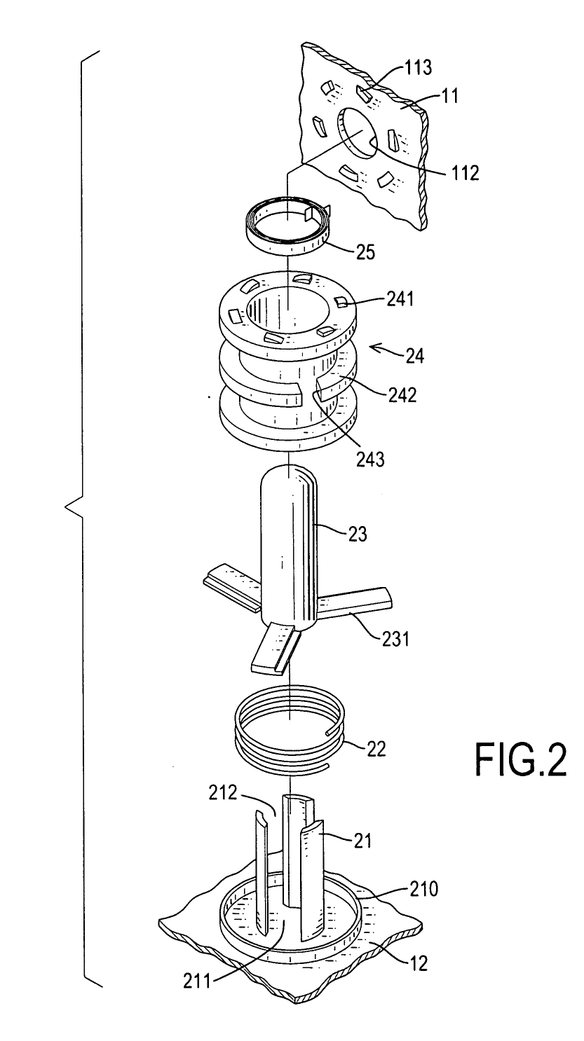

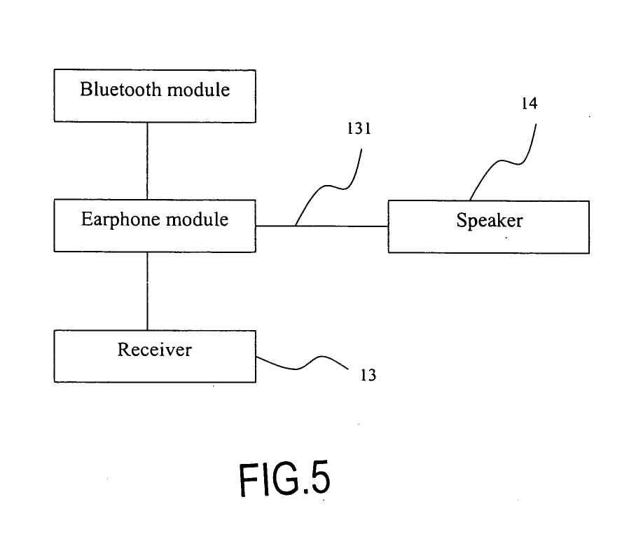

With reference to FIGS. 1 to 3 and 5, a bluetooth earphone in accordance with the present invention has an upper shell (11), a lower shell (12), an earphone module, a bluetooth module, a receiver (13), a rolling assembly (20) and a speaker (14).

The upper shell (11) has multiple receiving holes (111), a through hole (112), multiple key recesses (113) and an opening (114). The receiving holes (111) are defined separately in a first end of the upper shell (11). The through hole (112) are defined through the upper shell (11). The key recesses (113) are defined in the upper shell (11) and are formed around the through hole (112). The opening (114) is defined through a sidewall of the upper shell (11) adjacent to the through hole (112).

The upper shell (11) is engaged with the lower shell (12) to form an earphone jacket.

The earphone module is provided in the earphone jacket.

The bluetooth module is provided in the earphone jacket and electrically connects to the earphone module.

The receiver (13) is provided in the earphone jacket, electrically connects to the earphone module and corresponds to the receiving holes (11) so that sound can be emitted from the receiver (13) through the receiving holes (111).

The rolling assembly (20) is provided in the earphone jacket and corresponds to the through hole (112) in the upper shell (11). The rolling assembly (20) has multiple posts (21), a ring (210), a chamber (211), multiple gaps (212), a compression spring (22), a button (23), a wheel (24) and a coil spring (25). The posts (21) are separately formed uprightly on a lower end of the lower shell (12) and defines the chamber (211) between the posts (21). The gaps (212) are defined respectively between adjacent posts (21) and communicate with the chamber (211). The ring (210) is mounted around the posts (21). The compression spring (22) is mounted around the posts (21). The button (23) is provided in the chamber (211). The button (23) has multiple feet (231) formed transversely on a lower end of the button (23). A top end of the button (23) extends through the through hole (112) in the upper shell (11). The feet (231) are respectively extended in the gaps (212) to limit the button (23) to only move up and down relative to the posts (21) and presses against the compression spring (22). The wheel (24) is mounted around the posts (21). The wheel (24) has multiple lugs (241), a partition (242) and a cutout (243). The lugs (241) are formed on a top end of the wheel (24) and selectively engage with the key recesses (113) in the upper shell (11). The partition (242) is formed around a middle portion of the wheel (24). The cutout (243) is defined in the partition (242). The coil spring (25) is provided between the wheel (24) and the button (23). A first end of the coil spring (25) is attached to the wheel (24) and a second end of the coil spring (25) is attached to the posts (11) so that the wheel (24) can resume an original status with the resilient force of the coil spring (25).

The speaker (13) electrically connects to the earphone module via a wire (131). The wire (131) is rolled around the wheel (14) of the rolling assembly (20), is attached to the cutout (243) of the wheel (14) and extends out of the opening (114) of the upper shell (11).

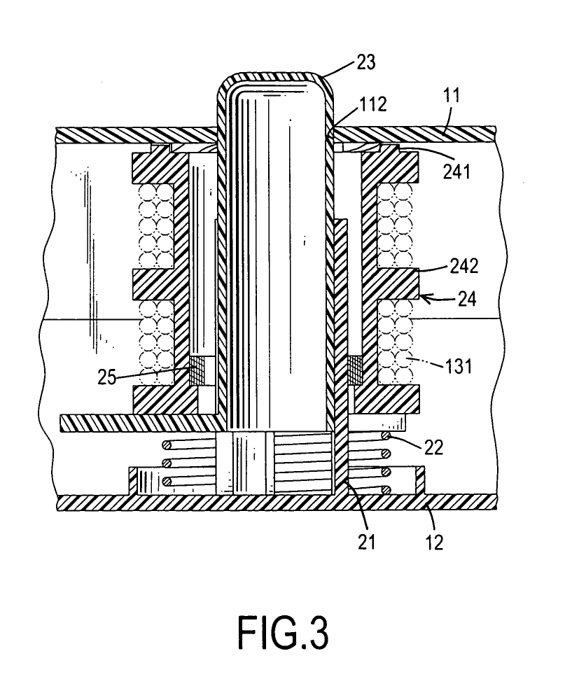

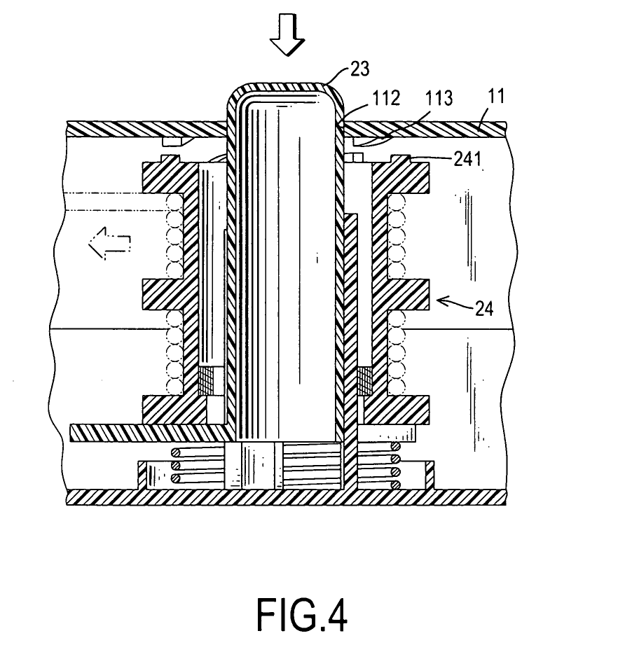

With reference to FIGS. 3 and 4, the key recesses (113) of the upper shell (11) engage with the lugs (241) of the wheel (24) so that the wheel (24) is kept from rotation relative to the button (23). The wire (131) can not be pulled out of the opening (114). When the button (23) is pressed downwards to disengage lugs (241) of the wheel (24) from the key recesses (113) of the upper shell (11), the wire (131) can be pulled out of the opening (141). Pulling the speaker (23) pulls the wire (131) out of the opening (141). When the wire (131) is pulled to a desired length, the button (23) is released and the compression spring (22) pushes the button (23) to move upward. Then the wheel (24) moves upward simultaneously and the lugs (241) of the wheel (24) engage the key recesses (113) of the upper shell (11) to keep the wheel (24) from rotating. Therefore, the extending length of the wire (131) is maintained. When the button (23) is pressed again, the elasticity of the coil spring (25) forces the wheel (24) to rotate and retracts the wire (131) into the earphone jacket.

With the rolling assembly (20), the wire (131) can be received in the earphone to avoid the wire (131) tangling.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A bluetooth earphone comprising:
an earphone jacket having
multiple receiving holes defined separately in the earphone jacket;
a through hole defined in the earphone jacket; and
an opening defined through a sidewall of the earphone jacket;
an earphone module provided in the earphone jacket and respectively connecting electrically to a bluetooth module, an receiver and a speaker wherein the speaker connects to the earphone module through a wire and the wire extends out of the opening; and
a rolling assembly provided in the earphone jacket and corresponding to the through hole and the opening, wherein the wire is rolled around the rolling assembly.

2. The bluetooth earphone as claimed in claim 1, wherein
the earphone jacket is composed of an upper shell and a lower shell;
the through hole is defined in the upper shell;
the upper shell has multiple key recesses defined in the upper shell and formed around the through hole;
the rolling assembly has
multiple posts separately formed uprightly on a lower end of the lower shell and defining a chamber between the posts;
multiple gaps defined respectively between adjacent posts and communicating with the chamber;
a compression spring mounted around the posts;
a button provided in the chamber and having
multiple feet formed transversely on a lower end of the button and extending respectively in the gaps between the posts; and
a top end of the button extending through the through hole in the upper shell;
a wheel mounted around the posts and having multiple lugs formed on a top end of the wheel and selectively engaging with the key recesses in the upper shell; and
a coil spring provided between the wheel and the button and having
a first end attached to the wheel; and
a second end attached to the posts.

3. The bluetooth earphone as claimed in claim 2, wherein the wheel has a partition formed in a middle portion of the wheel and a cutout defined in the partition.

4. The bluetooth earphone as claimed in claim 3, wherein the rolling assembly has three posts, three gaps and the button has three feet.
